(19) United States
(12) Patent Application Publication
(10) Pub. No.: US 2016/0113308 A1
(43) Pub. Date: Apr. 28, 2016

(54) EDIBLE SELF-ADHESIVE PARTICLES

(71) Applicant: Symrise AG, Holzminden (DE)

(72) Inventors: Thomas Henze, Holzminden (DE); lngo Lindner, Holzminden (DE); Jens Fahie, Holzminden (DE); Sergej Elenschleger, Holzminden (DE); Christopher Sabater, Holzminden (DE); Irene Frank, Vechta (DE)

(21) Appl. No.: 14/923,951

(22) Filed: Oct. 27, 2015

(30) Foreign Application Priority Data
Oct. 28, 2014 (EP) EP 14190746

(51) Int. Cl. A23L 1/00

(52) U.S. Cl. CPC A23L 1/0023; A23L 1/0061; A23V 2002/00

(57) ABSTRACT

The present invention relates to self-adhesive edible particles for applying and adhering to the surface of food or foodstuffs. The invention further relates to the preparation of foodstuffs comprising the self-adhesive edible particles according to the invention.

### FIELD OF THE INVENTION

The present invention relates to self-adhesive edible particles for applying and adhering to the surface of food or foodstuffs. The invention further relates to a method for the preparation of foodstuffs comprising the self-adhesive edible particles according to the invention.

### PRIOR ART

In the case of goods suitable for consumption (foodstuffs), it is frequently desirable to fix edible particles to, in or on the foodstuff. These particles may serve as decoration, to improve the external appearance or even to influence the sensory properties of the foodstuff, and also, for example, contribute to the taste profile, for example, in crisps.

The application of particles to and on foodstuffs is typically effected by means of starch, sugar alcohol, sugar-containing fixatives (adhesive), such as glazes, or by fat-containing fixatives such as fat coatings for example. However, sugar-containing fixatives also have a distinct sweetness and thus strongly affect the taste of the food, also the use of sugar-containing fixatives is undesirable, especially in the field of dietetic foods, due to their additional caloric values. Fat-containing fixatives impart a higher fat content to the food, which is particularly disadvantageous in the case of fat-reduced or low-fat foods. Moreover, the taste of the food also changes with increasing fat content.

Edible particulate adhesives for applying to foodstuffs are described, for example, in WO 02/091864 A1. The edible adhesive therein is based on a composition comprising modified starch, maltodextrin, edible surfactants and polysaccharides. The adhesive has a cohesiveness of 215 g/s to 700 g/s and has a viscosity of not more than 800 cps.

The adhesive described in U.S. Pat. No. 6,846,502 B1 is an edible hot melt anhydrous composition comprising (20 to 30% by weight) starch and plasticizer in order to adhere particulate additives such as flavourings and/or colouring agents to food.

U.S. Pat. No. 4,981,707 likewise describes an edible adhesive, particularly for use in the production of roasted nuts with a certain aromatic coating, comprising dextrin and a minor proportion of gum which is xanthan, carboxymethylcellulose or mixtures thereof.

Fat-free and oil-free edible foodstuff adhesives are known from U.S. Pat. No. 5,827,553, the composition of which comprises starch hydrolysate having a dextrose equivalent of 4-38 and a molecular weight of 400 to 4000 and also alcohols having 1 to 4 hydroxyl groups, polymerized glycol having an average molecular weight of 200 to 9500 and a solvent.

Sugar-based edible adhesives, which are obtainable by reacting sugar with polyfunctional acids, are disclosed in U.S. Pat. No. 6,613,378 B1.

EP 0722273 B1 describes an edible adhesive comprising an at least partially amorphous form of a mixture of at least one monosaccharide and at least one aliphatic, saturated polyalcohol having three to six carbon atoms.

An edible adhesive for applying flavourings to foodstuffs, composed of water, lactose and maltodextrin, is described in U.S. Pat. No. 4,738,865.

The object of the present invention therefore consists of finding a novel adhesion system, conforming to foodstuff regulations, in order to apply edible particles to food and to fix them thereto. In particular, the novel adhesion system (fixative) should have no, or a defined, flavour of its own and enable good fixing of the particle. In addition, it was an object of the invention to find an edible adhesion system that allows a simple and precise fixing and is stable on storage.

The novel edible adhesion system should also have no stickiness on the product after use, to prevent any unwanted sticking of the product to itself. Furthermore, the novel adhesion system should have as far as possible an improved process economy.

### DESCRIPTION OF THE INVENTION

The present invention relates to the use of particles consisting of a matrix comprising the following components:

(a) 0.001% by weight to 20% by weight flavourings,
(b) 0% by weight to 90% by weight fillers
(c) 0% by weight to 10% by weight emulsifiers,
(d) 0.001% by weight to 20% by weight colourants,
(e) 0% by weight to 10% by weight fibrous materials,
(f) 0% by weight to 90% by weight fat,
(g) 0% by weight to 5% by weight water,
(h) 0% by weight to 20% by weight spices, spice extracts and other pulverulent foodstuffs, with the proviso that the individual constituents of the composition add up to 100% by weight, as self-adhesive edible particles.

In a first preferred embodiment, particles are used in which the matrix is composed of one or more of the following components:

(a) 0.001% by weight to 20% by weight flavourings,
(b) 40% by weight to 90% by weight fillers
(c) 0% by weight to 10% by weight emulsifiers,
(d) 0.001% by weight to 20% by weight colourants,
(e) 0% by weight to 10% by weight fibrous materials,
(f) 0% by weight to 5% by weight water,
(g) 0% by weight to 20% by weight spices, spice extracts and other pulverulent foodstuffs, with the proviso that the individual constituents of the composition add up to 100% by weight.

In a second preferred embodiment, particles are used in which the matrix is composed of one or more of the following components:

(a) 0.001% by weight to 20% by weight flavourings,
(b) 0% by weight to 60% by weight fillers
(c) 0% by weight to 10% by weight emulsifiers,
(d) 0.001% by weight to 20% by weight colourants,
(e) 0% by weight to 10% by weight fibrous materials,
(f) 40% by weight to 90% by weight fat,
(g) 0% by weight to 5% by weight water,
(h) 0% by weight to 20% by weight spices, spice extracts and other pulverulent foodstuffs, with the proviso that the individual constituents of the composition add up to 100% by weight.

In a particularly preferred embodiment, a self-adhesive edible particle to be used in accordance with the invention has a composition comprising:

(a) 0.001% by weight to 20% by weight flavourings,
(b) 40% by weight to 90% by weight fillers
(c) 5% by weight to 10% by weight emulsifiers,
(d) 0.001% by weight to 20% by weight colourants,
(e) 2% by weight to 5% by weight fibrous materials,
(f) 3% by weight to 5% by weight water,
wherein the individual constituents of the composition add up to 100% by weight.

In a second particularly preferred embodiment, a self-adhesive edible particle to be used in accordance with the invention has a composition comprising:

(a) 0.001% by weight to 20% by weight flavourings,
(b) 5% by weight to 40% by weight fillers
(c) 2% by weight to 10% by weight emulsifiers,
(d) 1% by weight to 20% by weight colourants,
(e) 5% by weight to 10% by weight fibrous materials,
(f) 45% by weight to 65% by weight fat,
(g) 2% by weight to 5% by weight water,
wherein the individual constituents of the composition add up to 100% by weight.

An adhesion system has been found, surprisingly, in the form of particles consisting of the components a) to h) mentioned above, which is edible and at the same time self-adhesive. The edible particles according to the invention are particularly advantageous since they are self-adhesive, and enable optimized and selective fixing of the particles to the foodstuff to which they are to be applied on account of their particle shape. During the fixing, i.e. the application and adhesion to the foodstuff, the particles in this case are first of all warmed or heated so that the particles are melted before they are brought into contact with the foodstuff. The adhesion then takes place on the foodstuff at the melted point(s) of the particles. A further advantage in this case is that an active cooling step is generally no longer required after the adhesion. The product is simply left to cool (slowly) after the successful fixing.

### Flavourings

Suitable flavourings for producing the particles of the present invention can be found in, for example, “Fragrances”, in Steffen Arctander, in “Perfume and Flavor Chemicals”, Eigenverlag, Montclair, N. J. 1969; H. Surburg, J. Panten, in “Common Fragrance and Flavor Materials”, 5th Edition, Wiley-VCH, Weinheim 2006. Examples to be mentioned include: esters (saturated or unsaturated) such as ethyl butyrate, allyl caproate, benzyl acetate, methyl salicylate; organic acids (saturated and unsaturated) such as butyric acid, acetic acid, methylbutyric acid, caproic acid, alcohols (saturated and unsaturated) such as ethanol, propylene glycol, octenol, cis-3-hexanol, benzyl alcohol, phenylethyl alcohol; aldehydes (saturated and unsaturated) such as acetaldehyde, isobutyraldehyde, nonadienal, benzaldehyde, 3-phenylacetaldehyde; ketones such as menthone; ethers such as 4-hydroxy-5-methylfuranone, 3-hydroxy-4,5-dimethyl-2-(5H)-furanone, 2,5-dimethyl-3-hydroxy-2(3H)furanone, 2(5)-ethyl-4-hydroxy-5(2)-methyl-3(2H)-furanone, p-methoxybenzaldehyde, guaiacol, methoxyvinyl phenol; acetals such as acetaldehyde diethyl acetal; lactones such as gamma-decalactone; terpenes such as limonene, linalool, terpinene, terpineol, citral (geranial and neral), menthol; sulphides and disulphides such as dimethyl sulphide, difurfuryl disulphide, methylthiopropanal; thiols such as methylfuranthiol; pyrazines and pyrrolines such as methylpyrazine, acetylpyrazine, 2-propionylpyrroline, 2-acetylpyrroline, acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidenephthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dimethyl anthranilate, dodecalactone, ethoxyethyl acetate, ethylbutyric acid, ethyl butyrate, ethyl caprate, ethyl caproate, ethyl crotonate, ethyl furaneol, ethylguaiacol, ethyl isobutyrate, ethyl isovalerate, ethyl lactate, ethyl methylbutyrate, ethyl propionate, eucalyptol, eugenol, ethyl heptanoate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzyl acetone, isoamyl alcohol, isoamyl isovaleriate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methyl cyclopentenolone, 6,5,2-methyl heptenone, methyl dihydrojasmonate, methyl jasmonate, 2-methyl methylbutyrate, 2-methyl-2-pentenolic acid, methyl thiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovaleriate, piperonal, propionaldehyde, propyl butyrate, pulegone, pulegol, sinensal, sulphurol, terpinolene, 8,3-thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3(2H)-furanone and derivatives thereof (here preferably homofuraneol (=2-ethyl-4-hydroxy-5-methyl-3(2H)furanone), homofuronol (=2-ethyl-5-methyl-4-hydroxy-3(2H)-furanone and 5-ethyl-2-methyl-4-hydroxy-3(2H)-furanone), maltol and maltol derivatives (here preferably ethylmaltol), coumarin and coumarin derivatives, gamma-lactone (here preferably gamma-undecalactone, gamma-nonalactone, gamma-decalactone), delta-lactones (here preferably 4-methyldeltadecalactone, massoia lactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, isoamyl acetate, ethyl butyrate, n-butyl butyrate, isoamyl butyrate, ethyl 3-methylbutyrate, ethyl n-hexanoate, allyl n-hexanoate, n-butyl n-hexanoate, ethyl n-octanoate, ethyl 3-methyl-3-phenylglycidate, ethyl 2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl) disulphide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol and also (not explicitly mentioned here) stereoisomers, enantiomers, positional isomers, diastereomers, cis/trans-isomers or epimers of these substances.

### Fillers

Suitable as fillers for the preparation of the particles to be used in accordance with the invention are preferably starch degradation products such as dextrins, vegetable and animal proteins, starch, modified starch, sugar and sugar syrups such as sucrose, glucose, glucose syrup, fructose, maltose, ribose, lactose, xylose, polyols and sugar alcohols such as preferably isomalt, sorbitol, mannitol, xylitol, lactitol, glycerol, maltitol, erythritol, polydextrose, hydrocolloids and derivatives thereof such as cellulose, pectin, guar seed flour, carob seed flour, gelatine, agar agar, konjak gum, gum arabic, alginate, carrageen, xanthan, gellan gum and mixtures thereof.

### Emulsifiers

Suitable as emulsifiers for the preparation of the particles to be used in accordance with the invention are preferably monoglycerides, diglycerides and lecithins.

Suitable as colourants for the preparation of the to be used in accordance with the invention are preferably coloured foods such as beetroot etc., natural colourants such as chlorophyll, nature-identical colourants.

### Fibrous Materials

Suitable fibrous materials for the preparation of the particles to be used in accordance with the invention are preferably plant fibres such as apple, citrus, oat, potato, onion and wheat fibres.

### Fats

Suitable fats for the preparation of the particles to be used in accordance with the invention are preferably fats having a melting temperature of above 40° C., preferably above 50° C., preferably hard fats, such as triglycerides, preferably based on palm oil, palm kernel oil, coconut oil and tristearin, and also beef tallow.

### Commercial Applicability

Of particular advantage is that the edible particles to be used in accordance with the invention are self-adhesive such that a method step can be omitted by using the edible particles according to the invention. In the prior art for instance, firstly the fixative (adhesion agent) is added to the foodstuff, and then the additive particles to be adhered, in order to adhere the additive to the food. In the present invention, a novel adhesive concept was developed by means of the newly found adhesion system. Self-adhesive edible additive particles are produced, which no longer require separate fixatives, such that a method step in the production line of such food can be omitted.

A further aspect of the present invention, therefore, is the use of the edible self-adhesive particles mentioned above as an adhesion system for applying and adhering additive particles to the surface of food or foodstuffs.

A preferred embodiment is also the use of the self-adhesive edible particles mentioned for fixing edible particles to food.

By means of the fixing of particles according to the present invention, improved or novel food products can be obtained in an ideal manner, particularly from an optical or flavouring point of view. Owing to the self-adhesive edible particles to be used in accordance with the invention, totally novel compositions can be put together with the widest variety of particles which allows, on consuming the novel food products, different flavouring experiences to be perceived simultaneously, but particularly consecutively, during the consumption. The appearance and the taste experience can therefore be varied as desired, especially when particles with different flavour and appearance are fixed on the food. For instance, pizza-like snacks for example can be produced with the self-adhesive edible particles to be used in accordance with the invention, which are characterized by a novel texture and a novel appearance, and in particular by a potential improved and novel taste experience.

The term “edible particle” has a broad meaning since the nature of the particles is not critical to the functioning of the invention and the particles are only selected afterwards which have the flavours to be imparted to the preparations. The particles can be varied in size and shape over a wide range, and the properties, composition, manufacture and source is likewise not critical. The particle size is typically in the range of 0.1 to 50 mm, preferably in the range of 1 to 30 mm and particularly in the range of 2 to 5 mm. The particles may impart flavour or be flavourless, and be coloured, dyed, colourless and also transparent particles.

In a preferred embodiment of the self-adhesive edible particles to be used, the self-adhesive edible particles are preferably present in the form of powder, compacts, capsules, agglomerates, compressed agglomerates, pellets, flavour compacts or extrudates.

The self-adhesive edible particles of the present invention to be used are obtainable by methods which are already known from the prior art such as, by way of preference, extrusion, nozzle coextrusion, melt extrusion, spray chilling, pressure agglomeration, melt casting, pelleting, tableting or other granulation processes.

Particles prepared by the aforementioned methods are particularly advantageous because they are well suited for use in particular for the purpose of the invention, especially since the form and composition of the particles can be variably adjusted by the various methods, according to need and application field.

The self-adhesive edible particles of the present invention to be used may be prepared, for example, from an extruded melt. The melt is preferably an aromatized melt in which volatile flavourings and/or fragrances or volatile flavouring compositions and/or fragrance compositions are distributed. Support materials used here are preferably sucrose, glucose, lactose, fructose, maltose, ribose, dextrose, isomalt, sorbitol, mannitol, xylitol, lactitol, malitol, pentatol, arabinose, pentose, xylose, galactose, Trehalose®, (hydrogenated) corn syrup, maltodextrin, agar, carrageen, gums, polydextrose and derivatives and mixtures thereof. The preparation of such particles are known, for example, from EP 1 124 442 B1 or EP 1 501 375 B1.

The self-adhesive edible particles of the present invention to be used preferably have a glass transition temperature between 30° C. and 100° C. and average particle sizes of 0.6 to 3.0 mm. They are mostly spherical granules but which are also obtainable in the form of needles. Such a vitreous matrix may have a flavouring or fragrance loading of 3% by weight to 10% by weight, preferably 4% by weight to 8% by weight. The flavouring or fragrance loading can be variably adjusted according to need and field of application.

The self-adhesive edible particles to be used are preferably flavour particles having a glass transition temperature in the range of 30° to 100° C.

In a preferred embodiment, the self-adhesive edible particles to be used are particles consisting largely of a sugar-containing matrix. They are preferably compacts, i.e. compressed powder. The support materials used for the compacts are preferably carbohydrate compounds, which may be loaded with further ingredients, wherein the granules preferably have a particle size of 0.3 to 5 mm, preferably 0.4 to 3.2 mm. A compact to be used according to the invention advantageously has less than 7% by weight, preferably less than 5% by weight water and has 3% by weight to 30% by weight, preferably 4% by weight to 25% by weight, particularly preferably 5% by weight to 20% by weight flavouring or fragrance loading. The compacts used according to the invention can preferably be furnished with further additives such as acids, vitamins, dietary fibre, salts, etc depending on the application requirement and field of use.

In a preferred embodiment, the self-adhesive edible particles to be used are granules arising from a granulation process in which an emulsion or dispersion of the composition mentioned is heated in a stirred tank and subsequently the mixture is compressed by means of vibrating nozzles such as a shower nozzle. The drops thus obtained then fall into a cooling bath or calcium bath, depending on the application requirement, and solidify therein. Granules or particles thus prepared preferably consist largely of a fat matrix.

In a preferred embodiment, an edible fixative according to the invention comprises a mixture of various components a) (flavourings). These preferably take the form of particles which differ from one another in their flavouring or fragrance composition.

In a preferred embodiment, mixtures of several particles are used for applying and adhering of the particles to be used according to the invention, which may each have different weight percentages of the respective components a) to h), as already described above.

In a further preferred embodiment, mixtures of several particles are used for applying and adhering of the edible self-adhesive particles to be used according to the invention, wherein a first portion of the particles preferably comprises

(i) a first composition comprising or consisting of
(a) 0.001% by weight to 20% by weight flavourings,
(b) 40% by weight to 90% by weight fillers
(c) 0% by weight to 10% by weight emulsifiers,
(d) 0.001% by weight to 20% by weight colourants,
(e) 0% by weight to 10% by weight fibrous materials,
(f) 0% by weight to 5% by weight water,
(g) 0% by weight to 20% by weight spices, spice extracts and other pulverulent foodstuffs,
wherein the individual constituents of the composition add up to 100% by weight, and a second portion of the particles
   (i) comprises a second composition comprising or consisting of
(a) 0.001% by weight to 20% by weight flavourings,
(b) 0% by weight to 60% by weight fillers
(c) 0% by weight to 10% by weight emulsifiers,
(d) 0.001% by weight to 20% by weight colourants,
(e) 0% by weight to 10% by weight fibrous materials,
(f) 40% by weight to 90% by weight fat,
(g) 0% by weight to 5% by weight water,
(h) 0% by weight to 20% by weight spices, spice extracts and other pulverulent foodstuffs,
wherein the individual constituents of the composition add up to 100% by weight.

It has also been shown for the adhering to a food of the edible self-adhesive particles to be used according to the invention that the particles should have a certain proportion of components that determine the meltable proportion of the particles. In the particles to be used according to the invention, these components are preferably the fat components (f) or the content of carbohydrates, particularly of sugar compounds. The meltable portion of a particle to be used according to the invention has an influence on the quality of the fixing of the particle to the food.

Accordingly, a preferred embodiment consists in that the meltable portion in a particle to be used according to the invention is not below 3% by weight, preferably not below 5% by weight, especially preferably not below 8% by weight. With this amount of meltable components, good stickiness and therefore good adhesion of the particles to the food take place.

It has further been found that an excessive proportion of starch in the particles to be used is disadvantageous, particularly when using particles having a high content of sugar compounds. In the case of an excessive amount of starch in such particles, the particles to be used according to the invention melt very poorly or not at all such that few or hardly any bonding points are present which in turn leads to a poor adhesion outcome.

Accordingly, in a preferred embodiment, the proportion of starch in the particles to be used in accordance with the invention, particularly in the use of particles having a high content of sugar compounds, is preferably not above 60% by weight, preferably not above 70% by weight, especially preferably not above 90% by weight.

The edible particles to be used in accordance with the invention can be varied in size and shape over a wide range, and the properties, composition, manufacture and source is likewise not critical.

The size of a self-adhesive edible particle to be used in accordance with the invention is typically in the range of 0.1 to 50 mm, since they are particularly suitable as self-adhesive particles. In a preferred embodiment, self-adhesive edible particles to be used in accordance with the invention have an average particle size of preferably 0.1 to 50 mm, particularly preferably 0.1 to 20 mm, especially preferably 0.5 to 5 mm. The particle sizes specified here should not be limiting. The particle sizes are adjusted according to the required use such that particles of any size can be prepared and are preferred.

The self-adhesive edible particles to be used in accordance with the invention may be particles that impart flavour or be flavourless, and be coloured, dyed, colourless and also transparent. The particles preferably have a low water content such that the water content is in a range of not more than 5% by weight.

With the particles to be used in accordance with the invention, good fixing to the surface of food is possible with no problem, even of relatively large and heavy particles. The degree of fixing depends not only on the amount of the particles, but also includes the shape, water content and properties of the particle and of the food.

The present invention further relates in particular to the use of the particles to be used in accordance with the invention for fixing edible particles to food, preferably for applying and adhering of edible particles to the surface of food.

Preference is given to applying particles to be used in accordance with the invention to food preferably having relatively large surfaces. These foods typically have a size above 5 mm, the size usually being in the range of 10 to 200 mm.

Preference is given to carbohydrate-rich products such as flour or starch products, particularly baked goods, fried food or dried extruded food. The particles are typically applied to pastry, preserved baked goods or snacks such as crackers, pretzels, biscuits, potato or corn chips (e.g. tortilla chips), wheat flour products, (e.g. savoury sticks, croutons, bread chips, rusks, extruded and non-extruded crispbreads). Common shapes are triangles, squares, rectangles, trapezoids, cones, cubes, blocks, cylinders, spirals, rods, spheres, disks, strips, bars, circles, balls, ovals, shells, pyramids, octahedra, prisms or ellipses. The surfaces, however, may also exist in any desired shape. For snacks for example, animal shapes such as crocodiles, fish or kangaroos are also conceivable.

A low water content of the surface on or to which the particles are fixed is preferable. Advantageously, the particles are applied to dried, baked or fried food having a water content less than or equal to 15% by weight.

Accordingly, the present invention further relates to food or foodstuff comprising the particles to be used in accordance with the invention. In a preferred embodiment in this case, the food or foodstuff is selected from the group consisting of crisps, tortilla chips, nut products, french fries, pretzels, snack mixtures, crackers, popcorn, muesli, biscuits, cookies, extruded snacks, muesli bars and cereals.

The term “food” or “foodstuff” particularly includes products which are food according to REGULATION (EC) No. 178/2002 OF THE EUROPEAN PARLIAMENT AND OF THE COUNCIL of 28 Jan. 2002. According to this Regulation, “food” are all substances or products that are intended to be, or can reasonably be expected to be ingested by humans in a processed, partially processed or unprocessed state.

The present invention further provides in particular a method for producing a food having self-adhesive edible particles comprising
(i) providing self-adhesive edible particles consisting of a matrix composed of one or more of the following components:
   (a) 0.001% by weight to 20% by weight flavourings,
   (b) 0% by weight to 90% by weight fillers
   (c) 0% by weight to 10% by weight emulsifiers,
   (d) 0.001% by weight to 20% by weight colourants,
   (e) 0% by weight to 10% by weight fibrous materials,
   (f) 0% by weight to 90% by weight fat,
   (g) 0% by weight to 5% by weight water,
   (h) 0% by weight to 20% by weight spices, spice extracts and other pulverulent foodstuffs,
   wherein the individual constituents of the composition add up to 100% by weight;
(ii) heating the self-adhesive edible particles from (i) to a temperature at which the particles melt,
(iii) applying the melted self-adhesive edible particles from (ii) to the foodstuff, optionally in the presence of further spices, so that a foodstuff is obtained to which edible (additive) particles adhere.

In this case, as already described above, a mixture of different self-adhesive edible particles, which differ in the composition of components a) to h), are used as adhesion system. Such an application allows the fixing of different additive components to a food.

The application of the melted self-adhesive edible particles to the surface of the food can be carried out by known methods such as spreading, spraying, pouring, curtain coating, spin coating, brushing or dipping.

The melting range of the self-adhesive edible particles is a function of the size, shape and composition of the particles. For instance, self-adhesive edible particles may have a melting range of 70-150° C., preferably 80-140° C., particularly preferably 90-130° C., but may also exhibit a melting range of 80-170° C., preferably 90-160° C., particularly preferably 100-150° C. However, there are also particles which, depending on the composition thereof, exhibit a melting range of 25-95° C., preferably 30-80° C., particularly preferably 35-70° C.

A further advantage of the present invention is that a separate cooling of the particles may be omitted in the method according to the invention. Accordingly, the present invention further relates to the fact that the method according to the invention for producing a food having self-adhesive edible particles is a one-stage process which may be carried out continuously or batchwise.

The amount and type of application or affixing of the self-adhesive edible particles to the surface of the food can be varied within wide ranges, and is controlled, depending on the product requirements, by contact times, temperature regulation and matrix applied.

### EXAMPLES

### Preparation Examples

### Preparation of Particles According to the Invention

Particles A and B are prepared by means of roller compactors from Hosokawa Bepex GmbH.

| | | |
|---|---|---|
| Compression force | 1-20 | kN/cm |
| Roller speed: | 1-30 | rpm |
| Compression slit: | 1-6 | mm |

The granules are produced at room temperature. For this purpose, the powder mixture of the ingredients of particles A and B is delivered via a hopper system onto the slit between two rotating rollers which pressurize the powder into the slit with a certain compression force so that a coherent flake is formed from the powder. This flake is then comminuted in a granulator beneath the rollers. The size of the granules can be adjusted by means of a sieve.

TABLE 1
Particle A

| Ingredients | % by weight |
|---|---|
| Dextrin from corn | 77.82 |
| Mannitol | 10.00 |
| Monoglycerides | 1.10 |
| Drinking water | 2.00 |
| Cheese powder | 4.00 |
| Spice extracts | 0.07 |
| Cheese flavouring composition | 5.01 |
| Total | 100.00 |

TABLE 2
Particle B

| Ingredients | % by weight |
|---|---|
| Tristearin | 60.00 |
| Lecithin | 5.00 |
| Drinking water | 5.00 |
| Polydextrose | 10.00 |
| Tomato flavouring composition | 10.00 |
| Apple fibres | 8.00 |
| Table salt | 2.00 |
| Total | 100.00 |

### Example 1

Particle A was admixed during the preparation with various spices and flavourings so that self-adhesive edible particles were obtained imparted with different flavours.

TABLE 3
Particle A with various spice mixtures

Particle mixture [% by weight]

| Ingredients | 1 | 2 | 3 | 4 | 5 | 6 |
|---|---|---|---|---|---|---|
| Tomato | 52 | 56 | 53 | — | — | — |
| Onion | 21 | 14 | — | — | 56 | 20 |
| Cheddar cheese | 17 | 21 | — | 29 | — | 20 |
| Green chilli | 10 | 9 | — | — | — | 10 |
| Mozarella cheese | — | — | 33 | 29 | — | — |
| Basil | — | — | 14 | — | — | — |
| Beef | — | — | — | — | 44 | 20 |
| Tomato ketchup | — | — | — | — | — | 30 |
| Parmesan cheese | — | — | — | 29 | — | — |
| Red chilli | — | — | — | 13 | — | — |

TABLE 4
Particle A with various spice mixtures

Particle mixture [% by weight]

| Ingredients | 7 | 8 | 9 | 10 | 11 | 12 |
|---|---|---|---|---|---|---|
| Tomato | — | — | — | — | — | — |
| Onion | — | 57 | — | — | — | — |
| Cheddar cheese | 32 | — | 31 | 30 | 30 | 30 |
| Green chilli | 12 | — | 6 | | — | 20 |
| Mozarella cheese | 32 | — | 31 | 30 | 30 | 30 |
| Basil | — | — | — | — | — | — |
| Beef | — | 43 | — | — | — | — |
| Tomato ketchup | — | — | — | — | — | — |
| Parmesan cheese | 24 | — | 26 | 20 | 20 | 20 |
| Red chilli | — | — | 6 | 20 | 20 | — |

### Example 2

### Application of Edible Particles to Food Surface

The particles prepared in Example 1 were applied to snacks. For this purpose, the snacks (crisps) were charged in an application drum. The drum rotated at a speed of 8-15 revolutions per minute. The capacity should be chosen so that a good circulation of snacks is guaranteed, but the majority of the drum surface is covered.

Next the mass of the particles to be used is calculated from the snack weight and the desired order. In this case, a yield of about 70% is achieved. The particles according to the invention in Tables 1 and 2 are then filled into a hopper which feeds a compressed air driven vibrating chute. A heat source is directed into the application drum and preset to 620° C. The outlet of the hot air should be aligned perpendicular to the falling particles. The drive of the vibrating chute is activated. It is important to ensure that the particles are separated. The hot air stream melts the particles and at the same time conveys them on to the snack surface where they remain adhered. When the feed hopper is empty, the process is complete and the snack can be removed.

TABLE 5
Product loading after application to the surface of crisps.

| | | | Crisps + | |
|---|---|---|---|---|
| | | | Particle after | |
| Particle | Crisps [% | Particle [% | processing | |
| mixture | by weight] | by weight] | [% by weight] | Adhesion [%] |
| 1 | 83.3 | 16.7 | 94.8 | 69.0 |
| 2 | 83.4 | 16.6 | 92.5 | 54.9 |
| 3 | 83.3 | 16.7 | 94.4 | 66.6 |
| 4 | 83.4 | 16.6 | 92.1 | 52.5 |
| 5 | 83.4 | 16.6 | 91.1 | 46.7 |
| 6 | 83.3 | 16.7 | 92.9 | 57.6 |
| 7 | 80.0 | 20.0 | 92.2 | 60.8 |
| 8 | 83.5 | 16.5 | 93.8 | 62.1 |
| 9 | 83.1 | 16.9 | 91.5 | 50.0 |
| 10 | 83.1 | 16.9 | 97.7 | 86.7 |
| 11 | 83.1 | 16.9 | 96.0 | 76.7 |
| 12 | 83.1 | 16.9 | 96.6 | 80.0 |

Good adhesion yield (product loading) is evident which can go up to 80% by using the inventive edible fixative in particle form.

1-15. (canceled)

16. An edible particle with self-adhering properties, obtained by a process comprising the following steps:
(i) providing a matrix comprising the following components:
(a) about 0.001% b.w. to about 20% b.w. aroma compounds;
(b) about 40% b.w. to about 90% b.w. fillers;
(c) 0 to about 10% b.w. emulsifiers;
(d) about 0.001% b.w. to about 20% b.w. dyes;
(e) 0 to about 10% b.w. fibres;
(f) 0 to about 90% b.w. fats;
(g) 0 to about 5% b.w. water; and
(h) 0 to about 5% b.w. flavours, flavour extracts or related powdered food products,
on condition that the amounts of the composition add to 100% b.w.; and
(ii) subjecting the matrix according to step (i) to a granulation process.

17. The particle of claim 16, wherein the fillers are carbohydrates.

18. The particle of claim 17, wherein the carbohydrates are starches and degradation products of starches.

19. The particle of claim 17, having an amount of carbohydrates of up to 60% b.w.

20. The particle of claim 16, having a meltable amount of at least 3% b.w.-calculated on the particles.

21. The particle of claim 16, having an average particle size of from about 0.1 to about 50 mm.

22. The particle of claim 16, having a glass transition temperature of from about 100 to about 130° C.

23. The particle of claim 16, wherein the granulation process is selected from the group consisting of extrusion, nozzle-co extrusion, melt extrusion, spray-chilling, press agglomeration, melt moulding, pelletizing and tableting.

24. A method for obtaining edible particles with self-adhering properties, comprising the following steps:
(i) providing a matrix comprising the following components:
(a) about 0.001% b.w. to about 20% b.w. aroma compounds;
(b) about 40% b.w. to about 90% b.w. fillers;
(c) 0 to about 10% b.w. emulsifiers;
(d) about 0.001% b.w. to about 20% b.w. dyes;
(e) 0 to about 10% b.w. fibres;
(f) 0 to about 90% b.w. fats;
(g) 0 to about 5% b.w. water; and
(h) 0 to about 5% b.w. flavours, flavour extracts or related powdered food products,
on condition that the amounts of the composition add to 100% b.w.; and
(ii) subjecting the matrix of step (i) to a granulation process.

25. The method of claim 24 wherein step (ii) is selected from the group consisting of extrusion, nozzle-co extrusion, melt extrusion, spray-chilling, press agglomeration, melt moulding, pelletizing and tableting.

26. A food product coated with the edible particles of claim 16.

27. The food product of claim 26, selected from the group consisting of chips, tortilla chips, nut products, French fries, pretzels, snack mixtures, crackers, popcorn, mueslis, biscuits, cookies, extrudated snacks, muesli bars and cereals.

28. A method for coating the surface of a food product with edible particles, comprising the following steps:
(i) providing edible particles with self-adhering properties, and having a matrix comprising one or more of the following components:
(a) about 0.001% b.w. to about 20% b.w. aroma compounds;
(b) about 40% b.w. to about 90% b.w. fillers;
(c) 0 to about 10% b.w. emulsifiers;
(d) about 0.001% b.w. to about 20% b.w. dyes;
(e) 0 to about 10% b.w. fibres;
(f) 0 to about 90% b.w. fats;
(g) 0 to about 5% b.w. water; and
(h) 0 to about 5% b.w. flavours, flavour extracts or related powdered food products,
on condition that the amounts of the composition add to 100% b.w.;
(ii) heating the particles of step (i) to a temperature sufficient to begin melting said particles; and
(iii) adding the particles of step (ii) to the food product, optionally in the presence of additional flavours.
